(19) United States
(12) Patent Application Publication
(10) Pub. No.: US 2025/0104074 A1
(43) Pub. Date: Mar. 27, 2025

(54) SYSTEM AND METHOD FOR GENERATING FRAUD RULE CRITERIA

(71) Applicant: The Toronto-Dominion Bank, Toronto (CA)

(72) Inventors: Gabriel Kabo TSANG, Markham (CA); Feiyan ZHAO, Toronto (CA)

(73) Assignee: The Toronto-Dominion Bank, Toronto, ON (CA)

(21) Appl. No.: 18/472,401

(22) Filed: Sep. 22, 2023

(51) Int. Cl. G06Q 20/40; G06N 5/022

(52) U.S. Cl. CPC G06Q 20/4016; G06N 5/022

(57) ABSTRACT

A computer system comprises at least one processor; and a memory coupled to the at least one processor and storing processor-executable instructions which, when executed by the at least one processor, configure the at least one processor to create a first set of training data that includes data flagged as fraud and data flagged as not fraud; categorize the first set of training data into a number of first groups; for each first group, calculate at least one metric; compare the at least one metric to a number of first cutoff values; select a first cutoff value that generates a maximum performance output as a first threshold; flag at least one first group that has the at least one metric below the first threshold as risky; and generate fraud rule criteria based on the at least one first group.

### TECHNICAL FIELD

The present application relates to systems and methods for generating fraud rule criteria.

### BACKGROUND

Fraud occurs in financial and digital landscapes. Fraud detection utilizes algorithms to analyze data sets to identify anomalies and irregularities that may signify fraudulent behavior.

Fraud detection is difficult as fraudsters continually adapt their tactics.

### BRIEF DESCRIPTION OF THE DRAWINGS

Embodiments are described in detail below, with reference to the following drawings:

FIG. 1 is a high-level schematic diagram of an example computer system;

FIG. 2 shows a simplified organization of software components stored in a memory of the example computer system of FIG. 1;

FIG. 3 is a flowchart showing operations performed for generating fraud rule criteria according to an embodiment;

FIG. 4 is a flowchart showing operations performed for generating fraud rule criteria engine according to a second stage according to an embodiment;

FIG. 5 is a flowchart showing operations performed for selecting a first threshold according to an embodiment;

FIG. 6 is a flowchart showing operations performed for selecting a second threshold according to an embodiment; and

FIG. 7 is a flowchart showing operations performed for selecting a third threshold according to an embodiment.

Like reference numerals are used in the drawings to denote like elements and features.

### DETAILED DESCRIPTION OF VARIOUS EMBODIMENTS

Accordingly, in one aspect there is provided a computer system comprising at least one processor; and a memory coupled to the at least one processor and storing processor-executable instructions which, when executed by the at least one processor, configure the at least one processor to create a first set of training data that includes data flagged as fraud and data flagged as not fraud; categorize the first set of training data into a number of first groups; for each first group, calculate at least one metric; compare the at least one metric to a number of first cutoff values; select a first cutoff value that generates a maximum performance output as a first threshold; flag at least one first group that has the at least one metric below the first threshold as risky; and generate fraud rule criteria based on the at least one first group.

In one or more embodiments, the processor-executable instructions, when executed by the at least one processor, configure the at least one processor to create a second set of training data that includes all data from the first groups that were not flagged as risky.

In one or more embodiments, the processor-executable instructions, when executed by the at least one processor, configure the at least one processor to categorize the second set of training data into a number of second groups; for each second group, calculate at least one metric; compare the at least one metric to a number of predefined second cutoff values; select a second cutoff value that generates the maximum performance output as a second threshold; flag at least one second group that has the at least one metric below the second threshold as risky; and generate fraud rule criteria based on the at least one second group.

In one or more embodiments, the processor-executable instructions, when executed by the at least one processor, configure the at least one processor to create a third set of training data that includes all data from the second groups that were not flagged as risky.

In one or more embodiments, the processor-executable instructions, when executed by the at least one processor, configure the at least one processor to categorize the third set of training data into a number of third groups; for each third group, calculate at least one metric; compare the at least one metric to a number of predefined third cutoff values; select a third cutoff value that generates the maximum performance output as a third threshold; flag at least one third group that has the at least one metric below the third threshold as risky; and generate fraud rule criteria based on the at least one third group.

In one or more embodiments, the at least one metric includes at least one of a total amount of fraud approved, a total amount of fraud missed, a total amount of not fraud approved, a count of fraud, a count of not fraud, or a false positive rate.

In one or more embodiments, the first cutoff values include a plurality of false positive rate cutoff values.

In one or more embodiments, the first training set of data includes transaction data and comprises variables that include at least one of a nature of the transaction, a channel of the transaction, a merchant category for the transaction, a region of the transaction, authentication used for the transaction, a risk score, or a transaction amount.

In one or more embodiments, the first set of training data is categorized into the number of first groups based on at least one combination of one or more variables obtained from the first set of training data and the fraud rule criteria includes the at least one combination of the one or more variables.

In one or more embodiments, the processor-executable instructions, when executed by the at least one processor, configure the at least one processor to output computer program code that defines the fraud rule criteria.

According to another aspect there is provided a computer-implemented method comprising creating a first set of training data that includes data flagged as fraud and data flagged as not fraud; categorizing the first set of training data into a number of first groups; for each first group, calculating at least one metric; comparing the at least one metric to a number of predefined first cutoff values; selecting a first cutoff value that generates a maximum performance output as a first threshold; flagging at least one first group that has the at least one metric below the first threshold as risky; and generating fraud rule criteria based on the at least one first group.

In one or more embodiments, the method further comprises creating a second set of training data that includes all data from the first groups that were not flagged as risky.

In one or more embodiments, the method further comprises categorizing the second set of training data into a number of second groups; for each second group, calculating at least one metric; comparing the at least one metric to a number of predefined second cutoff values; selecting a second cutoff value that generates the maximum performance output as a second threshold; flagging at least one second group that has the at least one metric below the second threshold as risky; and generating fraud rule criteria based on the at least one second group.

In one or more embodiments, the method further comprises creating a third set of training data that includes all data from the second groups that were not flagged as risky.

In one or more embodiments, the method further comprises categorizing the third set of training data into a number of third groups; for each third group, calculating at least one metric; comparing the at least one metric to a number of predefined third cutoff values; selecting a third cutoff value that generates the maximum performance output as a third threshold; flagging at least one third group that has the at least one metric below the third threshold as risky; and generating fraud rule criteria based on the at least one third group.

In one or more embodiments, the at least one metric includes at least one of a total amount of fraud approved, a total amount of fraud missed, a total amount of not fraud approved, a count of fraud, a count of not fraud, or a false positive rate.

In one or more embodiments, the first cutoff values include a plurality of false positive rate cutoff values.

In one or more embodiments, the first training set of data includes transaction data and comprises variables that include at least one of a nature of the transaction, a channel of the transaction, a merchant category for the transaction, a region of the transaction, authentication used for the transaction, a risk score, or a transaction amount.

In one or more embodiments, the first set of training data is categorized into the number of first groups based on at least one combination of one or more variables obtained from the first set of training data and the fraud rule criteria includes the at least one combination of the one or more variables.

According to another aspect there is provided a non-transitory computer readable storage medium comprising computer-executable instructions which, when executed, configure at least one processor to create a first set of training data that includes data flagged as fraud and data flagged as not fraud; categorize the first set of training data into a number of first groups; for each first group, calculate at least one metric; compare the at least one metric to a number of first cutoff values; select a first cutoff value that generates a maximum performance output as a first threshold; flag at least one first group that has the at least one metric below the first threshold as risky; and generate fraud rule criteria based on the at least one first group.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

In one aspect of the present application, methods and systems are described for generating fraud rule criteria.

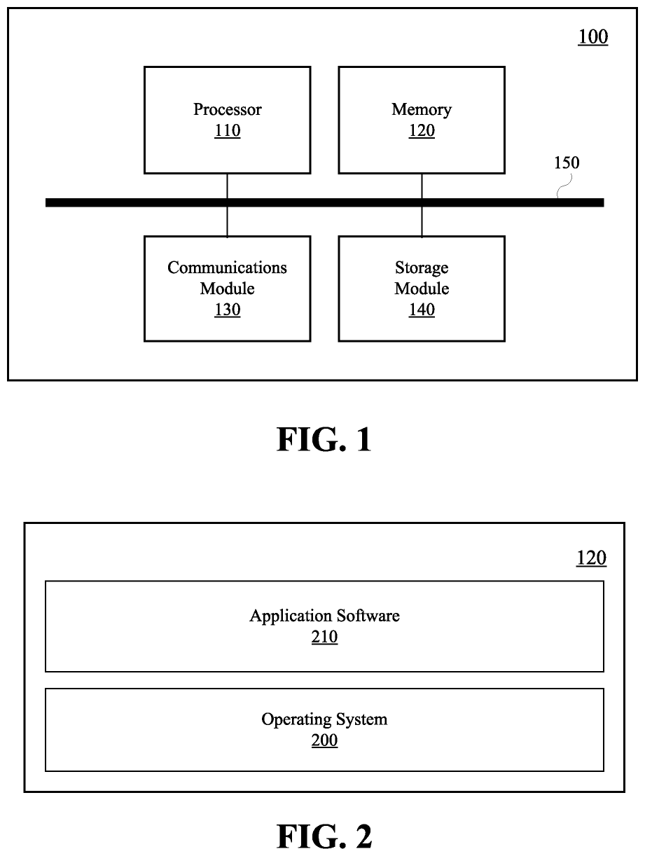

A high-level operation diagram of an example computer system 100 is shown in FIG. 1.

The example computer system 100 includes a variety of modules. For example, as illustrated, the example computer system 100 may include a processor 110, a memory 120, a communications module 130, and/or a storage module 140. As illustrated, the foregoing example modules of the example computer system 100 are in communication over a bus 150.

The processor 110 is a hardware processor. The processor 110 may, for example, be one or more ARM, Intel x86, PowerPC processors or the like.

The memory 120 allows data to be stored and retrieved. The memory 120 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computer system 100.

The communications module 130 allows the example computer system 100 to communicate with other computer or computing devices and/or various communications networks. For example, the communications module 130 may allow the example computer system 100 to send or receive communications signals. Communications signals may be sent or received according to one or more protocols or according to one or more standards. For example, the communications module 130 may allow the example computer system 100 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 130 may allow the example computer system 100 to communicate using near-field communication (NFC), via Wi-Fi™, using Bluetooth™ or via some combination of one or more networks or protocols. In some embodiments, all or a portion of the communications module 130 may be integrated into a component of the example computer system 100. For example, the communications module may be integrated into a communications chipset. In some embodiments, the communications module 130 may be omitted such as, for example, if sending and receiving communications is not required in a particular application.

The storage module 140 allows the example computer system 100 to store and retrieve data. In some embodiments, the storage module 140 may be formed as a part of the memory 120 and/or may be used to access all or a portion of the memory 120. Additionally or alternatively, the storage module 140 may be used to store and retrieve data from persisted storage other than the persisted storage (if any) accessible via the memory 120. In some embodiments, the storage module 140 may be used to store and retrieve data in a database. A database may be stored in persisted storage. Additionally or alternatively, the storage module 140 may access data stored remotely such as, for example, as may be accessed using a local area network (LAN), wide area network (WAN), personal area network (PAN), and/or a storage area network (SAN). In some embodiments, the storage module 140 may access data stored remotely using the communications module 130. In some embodiments, the storage module 140 may be omitted and its function may be performed by the memory 120 and/or by the processor 110 in concert with the communications module 130 such as, for example, if data is stored remotely. The storage module may also be referred to as a data store.

Software comprising instructions is executed by the processor 110 from a computer-readable medium. For example, software may be loaded into random-access memory from persistent storage of the memory 120. Additionally or alternatively, instructions may be executed by the processor 110 directly from read-only memory of the memory 120.

FIG. 2 depicts a simplified organization of software components stored in the memory 120 of the example computer system 100 (FIG. 1). As illustrated, these software components include an operating system 200 and an application 210.

The operating system 200 is software. The operating system 200 allows the application 210 to access the processor 110, the memory 120, and the communications module 130 of the example computer system 100 (FIG. 1). The operating system 200 may be, for example, Google™ Android™, Apple™ iOS™, UNIX™, Linux™, Microsoft™ Windows™, Apple OSX™ or the like.

The application 210 adapts the example computer system 100, in combination with the operating system 200, to operate as a device performing a particular function. For example, the application 210 may cooperate with the operating system 200 to adapt a suitable embodiment of the example computer system 100 to operate as a fraud detection engine.

As will be described in more detail, the fraud detection engine may be configured to generate fraud rule criteria and may automatically generate computer program code according to the fraud rule criteria. The computer program code may define one or more parameters or variables that may be used to detect, identify or flag potential fraud.

In one or more embodiments, the fraud detection engine may generate the fraud rule criteria by analyzing training data. The training data may include, for example, historical transaction data. The training data may be stored in a database and retrieved by the computer system 100 to train the fraud detection engine.

The training data may include historical transaction data associated with a large number of transactions. At least some of the historical transaction data may include transactions identified or known to be fraudulent and at least some of the historical transaction data may include transactions identified or known to be not fraudulent. Transactions identified or known to be not fraudulent may be referred to as legitimate transactions.

The transaction data may include one or more variables for each transaction represented thereby. The variables may include at least one of a nature of the transaction, a channel of the transaction, a merchant category for the transaction, a region of the transaction, authentication used for the transaction, a risk score, or a transaction amount. In one or more embodiments, variables for the training data may additionally include a binary flag that identifies whether or not the transaction was fraud or not fraud.

The nature of the transaction may identify the channel of the transaction, the merchant category for the transaction, and/or the region of the transaction.

The channel of the transaction which may identify whether the transaction was made online, whether the transaction is a recurring transaction, etc.

The merchant category for the transaction may identify a merchant category code. The merchant category code may include a four-digit number that classifies the type of goods or services the merchant who participated in the transaction is offering. The merchant category code may be defined by the International Organization for Standardization (ISO) such as those defined in ISO 18245:2023, for example.

The region of the transaction may include a geographic location identifying where the transaction took place. The geographic location may identify the country of the merchant who participated in the transaction, for example.

The authentication used for the transaction may identify one or more types of authentication used for the transaction. The types of authentication may include whether or not a card verification value (cvv) of a credit card was used, whether or not address verification was used, etc.

The risk score may identify a risk score for the transaction and may be defined or assigned from a third party service such as for example a Visa Advanced Authorization (VAA) score, a Visa Consumer Authentication Service (VCAS) risk score, a Falcon Fraud Manager risk score, etc.

The transaction amount may include a dollar amount for the transaction and may identify a currency of the transaction.

The fraud detection engine may be continuously or periodically trained using updated or recent training data. For example, the database may store and maintain historical data obtained from the last thirty (30) days. Each week, the fraud detection engine may be re-trained using the most recent thirty (30) days of historical data.

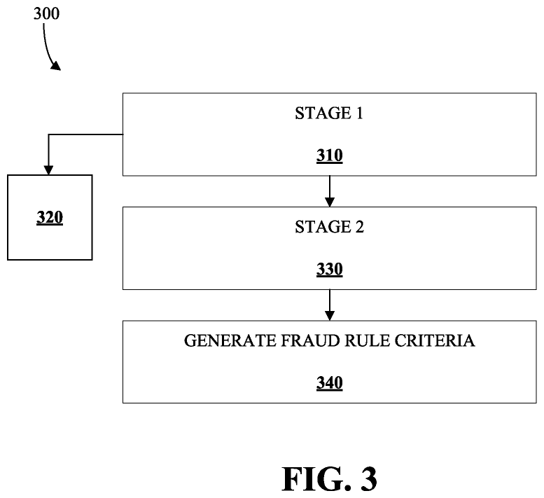

The training data is provided as input to the fraud detection engine to generate fraud rule criteria. Reference is made to FIG. 3, which illustrates, in flowchart form, a method 300 for generating fraud rule criteria. The method 300 may be implemented by a computing device having suitable processor-executable instructions for causing the computing device to carry out the described operations. The method 300 may be implemented, in whole or in part, by the fraud detection engine of the computer system 100.

The method 300 includes a first stage (step 310).

During the first stage, the fraud detection engine receives the training data as input. In one or more embodiments, the first stage may include filtering the training data. For example, the fraud detection engine may analyze the training data and may filter the training data based on one or more variables obtained therefrom.

In one or more embodiments, the training data may include historical transaction data. In these embodiments, the fraud detection engine may analyze the historical transaction data to identify the geographic location or country where each transaction took place. The fraud detection engine may filter out a transaction that was conducted in a country deemed to be “risky” and may filter the transaction data for the transaction into a data bucket 320. In this manner, the fraud detection engine may filter out any transactions that were conducted in countries deemed to be risky.

The method 300 includes a second stage (step 330).

Any transactions that were not assigned into the data bucket 320 may be passed through to the second stage. The second stage of fraud detection may include a tiered structure that may be used to flag or otherwise filter out transactions that are fraudulent or potentially fraudulent.

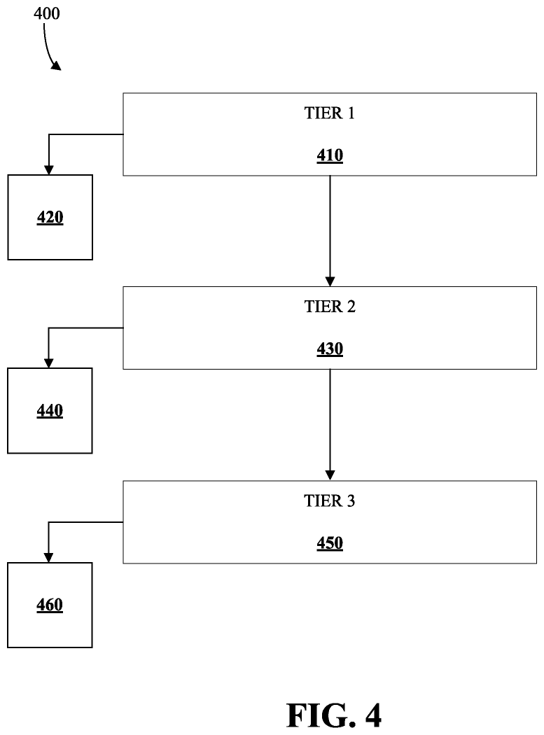

Reference is made to FIG. 4, which illustrates, in flowchart form, a method 400 for generating fraud rule criteria according to the second stage. The method 400 may be implemented by a computer system having suitable processor-executable instructions for causing the computer system to carry out the described operations. The method 400 may be implemented, in whole or in part, by the fraud detection engine of the computer system 100.

The method 400 includes a first tier (step 410).

The first tier includes generating a first set of training data and performing operations to select a first cutoff value that generates a maximum performance output as a first threshold.

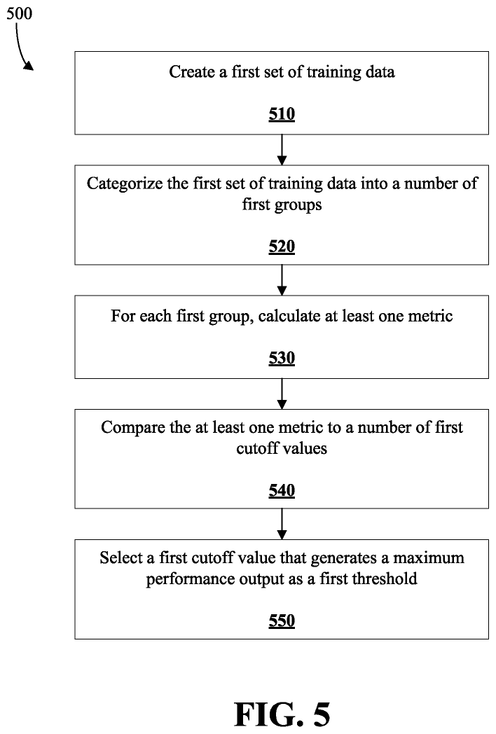

Reference is made to FIG. 5, which illustrates, in flowchart form, a method 500 for selecting the first threshold. The method 500 may be implemented by a computer system having suitable processor-executable instructions for causing the computer system to carry out the described operations. The method 500 may be implemented, in whole or in part, by the fraud detection engine of the computer system 100.

The method 500 includes creating a first set of training data that includes data flagged as fraud and data flagged as not fraud (step 510).

In one or more embodiments, the first set of training data includes the training data that was not filtered or assigned into the data bucket 320 during the first stage of the training. The first set of training data includes data flagged as fraud and data flagged as not fraud.

As mentioned, the training data may include historical transaction data that comprises one or more variables that include at least one of a nature of the transaction, a channel of the transaction, a merchant category for the transaction, a region of the transaction, authentication used for the transaction, a risk score, or a transaction amount. The variables may additionally include a binary fraud that identifies whether the transaction was fraud or not fraud.

The method 500 includes categorizing the first set of training data into a number of first groups (step 520).

The first set of training data is categorized into a number of first groups and this may be done based on at least one combination of one or more of the variables. For example, the first set of training data may be categorized into first groups based on the region of the transaction, the channel of the transaction, the authentication used for the transaction, and the risk score for the transaction. As another example, the first set of training data may be categorized into first groups based on the nature of the transaction, the authentication used for the transaction, the transaction amount and the risk score.

In one or more embodiments the first set of training data may be grouped and regrouped within the first tier. For example, the first set of training data may be grouped by the region of the transaction, the channel of the transaction, and the authentication used for the transaction. For each group, bins may be created for risk scores and transaction amount and this may be based on a mean and standard deviation of these variables. For example, the bins may be assigned based on a mean to mean plus one standard deviation. The first set of training data may then be regrouped by the region of the transaction, the channel of the transaction, the authentication used for the transaction, the risk scores, and the transaction amount.

The method 500 includes, for each first group, calculating at least one metric (step 530).

For each group, at least one metric is calculated. In one or more embodiments, the at least one metric may include a total amount of fraud missed and a false positive rate. The total amount of fraud missed may be a sum of the fraud missed in each first group. The false positive rate may represent a rate of non-fraud transactions that were wrongly characterized as fraud. The false positive rate may represent a probability that a false alarm will be raised. In one or more embodiments, the false positive rate may be calculated by determining a count of transactions wrongly characterized as fraud divided by a sum of the count of transactions wrongly characterized as fraud and a count of transactions correctly characterized as fraud.

The method 500 includes comparing the at least one metric to a number of first cutoff values (step 540).

The at least one metric is compared to a number of first cutoff values. In one or more embodiments, the first cutoff values may include a number of predetermined false positive rate cutoffs. For example, a first cutoff value may be a false positive rate of ten (10.0) and as such all groups having a false positive rate under ten (10.0) may be identified as risky. Other examples of first cutoff values may include false positive rates of nine (9.0), nine-point-five (9.5), etc. The number of first cutoff values may include a total of five (5) first cutoff values, ten (10) first cutoff values, twenty (20) first cutoff values, etc.

The method 500 includes selecting a first cutoff value that generates a maximum performance output as a first threshold (step 550).

The first cutoff values are evaluated to determine a cutoff value that generates a maximum performance output. In one or more embodiments, the maximum performance output may include a highest false positive rate allowed with a maximum incremental gain on overall fraud captured. As such, the first cutoff value that generates the highest false positive rate allowed with the maximum incremental gain on overall fraud captured is selected as the first threshold.

Responsive to selecting the first cutoff value that generates the maximum performance output as the first threshold, any first group that has the at least one metric below the first threshold is flagged as risky and may be filtered or assigned to a data bucket 420. The method 400 continues to the second tier.

The method 400 includes a second tier (step 430).

The second tier includes generating a second set of training data and performing operations to select a second cutoff value that generates a maximum performance output as a second threshold.

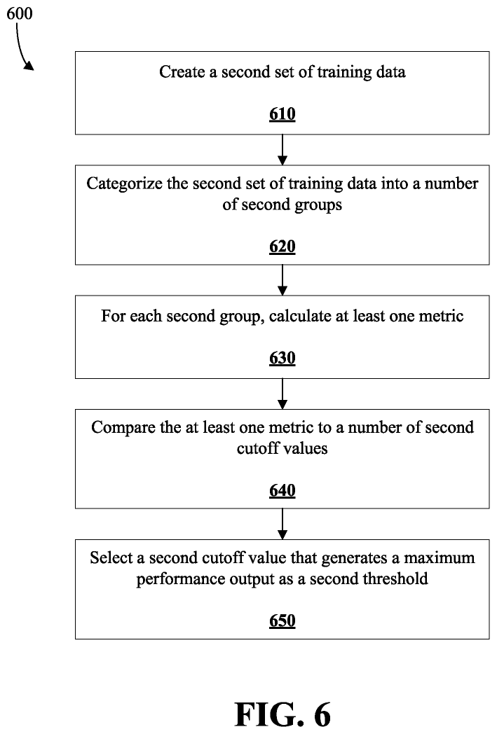

Reference is made to FIG. 6, which illustrates, in flowchart form, a method 600 for selecting the second threshold. The method 600 may be implemented by a computer system having suitable processor-executable instructions for causing the computer system to carry out the described operations. The method 600 may be implemented, in whole or in part, by the fraud detection engine of the computer system 100.

The method 600 includes creating a second set of training data (step 610).

In one or more embodiments, the second set of training data may include all data from the first groups that were not flagged as risky. Put another way, the second set of training data may include all data from the first groups that were not assigned to the data bucket 420. It will be appreciated that, when creating the second set of training data, the data is not yet grouped. Put another way, the data received or obtained from the first tier is ungrouped from the groups created during the step 520 of the method 500.

The method 600 includes categorizing the second set of training data into a number of second groups (step 620).

The second set of training data is categorized into a number of second groups and this may be done based on at least one combination of one or more of the variables. For example, the second set of training data may be categorized into second groups based on the channel of the transaction, the authentication used for the transaction, the region of the transaction, and the merchant category for the transaction. As another example, the second set of training data may be categorized into second groups based on the authentication used for the transaction, the region of the transaction, and the merchant category for the transaction.

The method 600 includes, for each second group, calculating at least one metric (step 630).

For each group, at least one metric is calculated. In one or more embodiments, the at least one metric may include a total amount of fraud missed and a false positive rate and this may be calculated in manners similar to that described above with reference to step 530 of the method 500.

The method 600 includes comparing the at least one metric to a number of second cutoff values (step 640).

The at least one metric is compared to a number of second cutoff values. In one or more embodiments, the second cutoff values may include a number of predetermined false positive rate cutoffs and this may be performed similar to step 540 of the method 500. One or more of the second cutoff values may be the same as one or more of the first cutoff values.

The method 600 includes selecting a second cutoff value that generates a maximum performance output as a second threshold (step 650).

The second cutoff values are evaluated to determine a cutoff value that generates a maximum performance output. In one or more embodiments, the maximum performance output may include a highest false positive rate allowed with a maximum incremental gain on overall fraud captured. As such, the second cutoff value that generates the highest false positive rate allowed with the maximum incremental gain on overall fraud captured is selected as the second threshold.

Responsive to selecting the second cutoff value that generates the maximum performance output as the second threshold, any second group that has the at least one metric below the second threshold is flagged as risky and may be filtered or assigned to a data bucket 440. The method 400 continues to the third tier.

The method 400 includes a third tier (step 450).

The third tier includes generating a third set of training data and performing operations to select a third cutoff value that generates a maximum performance output as a third threshold.

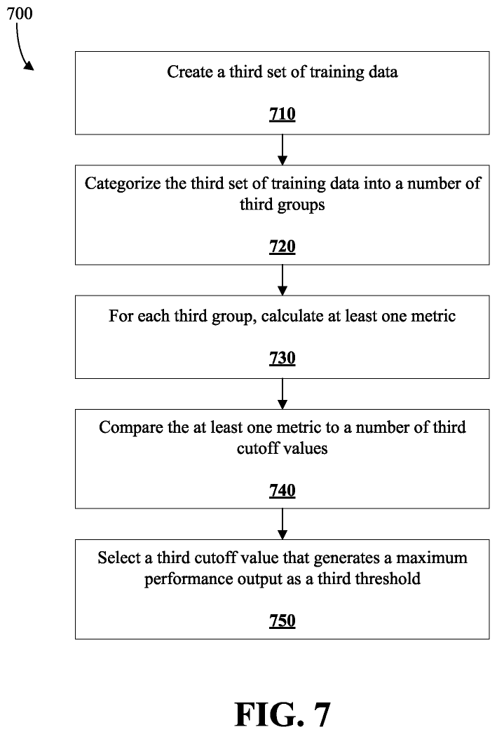

Reference is made to FIG. 7, which illustrates, in flowchart form, a method 700 for selecting the third threshold. The method 700 may be implemented by a computer system having suitable processor-executable instructions for causing the computer system to carry out the described operations. The method 700 may be implemented, in whole or in part, by the fraud detection engine of the computer system 100.

The method 700 includes creating a third set of training data (step 710).

In one or more embodiments, the third set of training data may include all data from the second groups that were not flagged as risky. Put another way, the third set of training data may include all data from the second groups that were not assigned to the data bucket 440. It will be appreciated that, when creating the third set of training data, the data is not yet grouped. Put another way, the data received or obtained from the second tier is ungrouped from the groups created during the step 620 of the method 600.

The method 700 includes categorizing the third set of training data into a number of third groups (step 620).

The third set of training data is categorized into a number of third groups and this may be done based on one or more of the variables. In one or more embodiments, the third set of training data may be categorized based on the at least one combination of one or more variables used to generate the first groups and the at least one combination of one or more variables used to generate the second groups. For example, the third set of training data may be categorized into third groups based on the nature of the transaction, the authentication used for the transaction, the amount of the transaction, the risk score, the region of the transaction, and the merchant category for the transaction.

The method 700 includes, for each third group, calculating at least one metric (step 630).

For each group, at least one metric is calculated. In one or more embodiments, the at least one metric may include a total amount of fraud missed and a false positive rate and this may be calculated in manners similar to that described above with reference to step 530 of the method 500.

The method 700 includes comparing the at least one metric to a number of third cutoff values (step 640).

The at least one metric is compared to a number of third cutoff values. In one or more embodiments, the third cutoff values may include a number of predetermined false positive rate cutoffs and this may be performed similar to step 540 of the method 500. One or more of the third cutoff values may be the same as one or more of the first cutoff values and/or the second cutoff values.

The method 600 includes selecting a third cutoff value that generates a maximum performance output as a third threshold (step 650).

The third cutoff values are evaluated to determine a cutoff value that generates a maximum performance output. In one or more embodiments, the maximum performance output may include a highest false positive rate allowed with a maximum incremental gain on overall fraud captured. As such, the third cutoff value that generates the highest false positive rate allowed with the maximum incremental gain on overall fraud captured is selected as the third threshold.

Responsive to selecting the third cutoff value that generates the maximum performance output as the third threshold, any third group that has the at least one metric below the third threshold is flagged as risky and may be filtered or assigned to a data bucket 460. Any third group that has the at least one metric above the third threshold is considered not risky and thus is not considered to be fraud.

Referring back to FIG. 3, responsive to completion of the third tier, the fraud detection engine may generate fraud rule criteria for identifying or detecting fraud (step 340). Specifically, the fraud detection engine may generate fraud rule criteria based on what groups have been assigned into the data buckets 420, 440, 460. For example, the fraud detection engine may generate a query that may be used for fraud rule criteria and the query may include variables used to generate the group that was assigned into one of the data buckets. In one or more embodiments, the query may be generated by concatenating all criteria (variables, thresholds, etc.) used to generate any group flagged or deemed to be “risky”.

Responsive to generating the fraud rule criteria, the fraud detection engine may format the fraud rule criteria into a particular computer-readable format and in this manner the fraud detection engine may output computer program code that defines criteria for identifying fraud. For example, the fraud detection engine may submit the fraud rule criteria to a computer program that includes a series of Python code that may automatically format the fraud rule criteria into Total System Services, Inc. (TSYS) code. The computer program may utilize Python modules such as for example pyodbc, numpy, pandas, etc. The output of the computer program may include a text or “txt” file that contains a production code version of the fraud rule criteria that can be directly used by a TSYS system. The TSYS system may automatically implement the fraud rule criteria such that any incoming transaction request may be analyzed according to the fraud rule criteria to identify or flag the transaction as fraudulent or potentially fraudulent and to conduct real-time decisioning as to whether or not to accept or decline the transaction.

As mentioned, in one or more embodiments, the fraud detection engine may be continuously trained or re-trained used the most recent thirty (30) days of historical transaction data and as such the fraud detection engine may be trained to identify new and emerging segments of fraud and as such may capture the most recent fraud patterns used by fraudsters.

Although in embodiments described herein the method for generating fraud rule criteria includes two stages and three tiers of analysis, it will be appreciated that variations are available. For example, in one or more embodiments, only the method 500 may be performed and this may be done to select a single threshold. In these embodiments, the fraud detection engine may generate a query that may be used for fraud rule criteria and the query may include variables used to generate a first group that was assigned into the data bucket 420 and the threshold used. As another example, an additional tier of analysis may be used and this may be performed similar to method 500, 600 and/or 700 described herein.

It will be appreciated that in one or more embodiments, the fraud detection engine may categorize the training data into different groups using different combinations of variables and may select one of the combinations of the variables as categorizing criteria for that particular tier. For example, the fraud detection engine may analyze the training data using all permutations and combinations of variables and may select a cutoff value and categorizing criteria for each tier.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer system comprising:
at least one processor; and
a memory coupled to the at least one processor and storing processor-executable instructions which, when executed by the at least one processor, configure the at least one processor to:
create a first set of training data that includes data flagged as fraud and data flagged as not fraud;
categorize the first set of training data into a number of first groups;
for each first group, calculate at least one metric;
compare the at least one metric to a number of first cutoff values;
select a first cutoff value that generates a maximum performance output as a first threshold;
flag at least one first group that has the at least one metric below the first threshold as risky; and
generate fraud rule criteria based on the at least one first group.

2. The computer system of claim 1, wherein the processor-executable instructions, when executed by the at least one processor, configure the at least one processor to:
create a second set of training data that includes all data from the first groups that were not flagged as risky.

3. The computer system of claim 2, wherein the processor-executable instructions, when executed by the at least one processor, configure the at least one processor to:
categorize the second set of training data into a number of second groups;
for each second group, calculate at least one metric;
compare the at least one metric to a number of predefined second cutoff values;
select a second cutoff value that generates the maximum performance output as a second threshold;
flag at least one second group that has the at least one metric below the second threshold as risky; and
generate fraud rule criteria based on the at least one second group.

4. The computer system of claim 3, wherein the processor-executable instructions, when executed by the at least one processor, configure the at least one processor to:
create a third set of training data that includes all data from the second groups that were not flagged as risky.

5. The computer system of claim 4, wherein the processor-executable instructions, when executed by the at least one processor, configure the at least one processor to:
categorize the third set of training data into a number of third groups;
for each third group, calculate at least one metric;
compare the at least one metric to a number of predefined third cutoff values;
select a third cutoff value that generates the maximum performance output as a third threshold;
flag at least one third group that has the at least one metric below the third threshold as risky; and
generate fraud rule criteria based on the at least one third group.

6. The computer system of claim 1, wherein the at least one metric includes at least one of a total amount of fraud approved, a total amount of fraud missed, a total amount of not fraud approved, a count of fraud, a count of not fraud, or a false positive rate.

7. The computer system of claim 1, wherein the first cutoff values include a plurality of false positive rate cutoff values.

8. The computer system of claim 1, wherein the first training set of data includes transaction data and comprises variables that include at least one of a nature of the transaction, a channel of the transaction, a merchant category for the transaction, a region of the transaction, authentication used for the transaction, a risk score, or a transaction amount.

9. The computer system of claim 1, wherein the first set of training data is categorized into the number of first groups based on at least one combination of one or more variables obtained from the first set of training data and the fraud rule criteria includes the at least one combination of the one or more variables.

10. The computer system of claim 1, wherein the processor-executable instructions, when executed by the at least one processor, configure the at least one processor to output computer program code that defines the fraud rule criteria.

11. A computer-implemented method comprising:
creating a first set of training data that includes data flagged as fraud and data flagged as not fraud;
categorizing the first set of training data into a number of first groups;
for each first group, calculating at least one metric;
comparing the at least one metric to a number of predefined first cutoff values;
selecting a first cutoff value that generates a maximum performance output as a first threshold;
flagging at least one first group that has the at least one metric below the first threshold as risky; and
generating fraud rule criteria based on the at least one first group.

12. The computer-implemented method of claim 11, further comprising:
creating a second set of training data that includes all data from the first groups that were not flagged as risky.

13. The computer-implemented method of claim 12, further comprising:
categorizing the second set of training data into a number of second groups;
for each second group, calculating at least one metric;
comparing the at least one metric to a number of predefined second cutoff values;
selecting a second cutoff value that generates the maximum performance output as a second threshold;
flagging at least one second group that has the at least one metric below the second threshold as risky; and
generating fraud rule criteria based on the at least one second group.

14. The computer-implemented method of claim 13, further comprising:
creating a third set of training data that includes all data from the second groups that were not flagged as risky.

15. The computer-implemented method of claim 14, further comprising:
categorizing the third set of training data into a number of third groups;
for each third group, calculating at least one metric;
comparing the at least one metric to a number of predefined third cutoff values;
selecting a third cutoff value that generates the maximum performance output as a third threshold;
flagging at least one third group that has the at least one metric below the third threshold as risky; and
generating fraud rule criteria based on the at least one third group.

16. The computer-implemented method of claim 11, wherein the at least one metric includes at least one of a total amount of fraud approved, a total amount of fraud missed, a total amount of not fraud approved, a count of fraud, a count of not fraud, or a false positive rate.

17. The computer-implemented method of claim 11, wherein the first cutoff values include a plurality of false positive rate cutoff values.

18. The computer-implemented method of claim 11, wherein the first training set of data includes transaction data and comprises variables that include at least one of a nature of the transaction, a channel of the transaction, a merchant category for the transaction, a region of the transaction, authentication used for the transaction, a risk score, or a transaction amount.

19. The computer-implemented method of claim 11, wherein the first set of training data is categorized into the number of first groups based on at least one combination of one or more variables obtained from the first set of training data and the fraud rule criteria includes the at least one combination of the one or more variables.

20. A non-transitory computer readable storage medium comprising computer-executable instructions which, when executed, configure at least one processor to:
create a first set of training data that includes data flagged as fraud and data flagged as not fraud;
categorize the first set of training data into a number of first groups;
for each first group, calculate at least one metric;
compare the at least one metric to a number of first cutoff values;
select a first cutoff value that generates a maximum performance output as a first threshold;
flag at least one first group that has the at least one metric below the first threshold as risky; and
generate fraud rule criteria based on the at least one first group.
